(19) United States
(12) Patent Application Publication
(10) Pub. No.: US 2011/0223391 A1
(43) Pub. Date: Sep. 15, 2011

(54) Ink Composition for Ink Jet Recording of the Active Energy Beam Curing Type, and Printed Article

(75) Inventors: Keiji Nishimura, Kanagawa (JP); Fumie Yamazaki, Kanagawa (JP); Syoichi Kumamoto, Kanagawa (JP)

(73) Assignee: THE INCTEC INC., Kanagawa (JP)

(21) Appl. No.: 12/306,674

(22) PCT Filed: Dec. 5, 2008
(86) PCT No.: PCT/JP2008/072587

§ 371 Date: Mar. 23, 2011

(51) Int. Cl. B32B 3/10; C08J 3/28

(52) U.S. Cl. 428/195.1; 522/39; 522/64

(57) ABSTRACT

The invention provides an ink composition for ink jet recording of the active energy beam curing type that comprises 30 to 80% by mass of a monofunctional acrylate having a monoalicyclic structure, 1 to 10% by mass of an urethane acrylate oligomer and 5 to 30% by mass of N-vinylcaprolactam together with a polymerization initiator and a coloring agent, and has a viscosity at 40° C. of 5 to 20 mPa·s and a surface tension of 20 to 50 mN/m. The ink composition exhibits good ejection capability and curability, is less smelling and of great safety, and has good adhesion to a variety of substrate materials.

### ART FIELD

The present invention relates generally to an ink composition for ink jet recording of the active energy beam curing type, and more particularly to an ink composition for ink jet recording of the active energy beam curing type, which is improved in adhesion to various hard and soft plastic materials and has great safety and few smells, and a printed article obtained using that ink composition.

### BACKGROUND ART

Recently, an ink jet printing mode using active energy beams have been studied hard. This mode involves applying a liquid ink on paper, plastics or the like and thereafter irradiating it with, for instance, ultraviolet radiation for curing and crosslinking, and has advantages of fast drying, solventless and printability to media incapable of absorbing ink over the prior art wherein curing and crosslinking are induced by heat. In addition, the ink jet mode requires no plate for printing, and feeds ink to the necessary image area alone to form images directly on the medium to be recorded, allowing for more efficient use of ink. For this reason, the ink jet mode has attracted attention.

The ink jet printing mode may be applied to various materials including soft materials such as polyvinyl chloride, and there are growing demands toward hard plastic materials such as polypropylene, methyl methacrylate plastics, PET and ABS, too. Indeed, however, a problem with polyolefinic materials like polypropylene and polyethylene, and polyethylene terephthalate (PET) is poorness in adhesion to ink. Especially when bending or other processing is applied to it after printing, there is a peeling or cracking problem. There are thus still demands for an ink composition that renders the ensuing printed matter unlikely to crack, peel off or otherwise fail, and is rich in the flexibility of the cured film and adhesion to substrates.

On the other hand, most of monomers and oligomers used for the energy beam curing type ink have more of irritation to the skin, often offering a safety problem such as erythema or edema due to ink before curing. The primary irritation index is set as one measure of irritation to the skin. The primary irritation index here is the one for irritation and erythema or edema to the skin. Estimation, for instance, may be made by ISO-10933 or Draize's improved method (J. H. Draize et al. “Method for the Study of Irritation and Toxicity of Substances Applied Topically to the Skin and Mucous Membrane”, Journal of the Pharmacology and Experimental Therapeutics, 82, 377, 1984), and measured according “The Code of Federal Regulations, Title 16, Section 1500.41” of The Consumer Product Safety Commission of the U.S.A. The primary irritation index (P.I.I.) is ranked:
P.I.I. 0.00-0.03: no irritation to the skin,
P.I.I. 0.04-0.99: very slight irritation to the skin,
P.I.I. 1.00-1.99: slight irritation,
P.I.I. 2.00-2.99: moderate irritation,
P.I.I. 3.00-5.99: moderate to severe irritation, and
P.I.I. 6.00-8.00: very severe irritation.

With worksite safety in mind, it is desired that the primary irritation index (P.I.I.) be less than 2.0.

So far, many energy beam curing type inks have been proposed. JP(A)2004-269690 proposes an active energy beam curable ink containing polyvinyl acetal, and JP(A)2006-160959 puts forward an ultraviolet curing type ink containing ester and ether bonds. However, because of increased ink viscosity, ejection temperatures must be maintained at 50 to 60° C., and too much energy is needed because the ink must be irradiated with much light for curing. Further, the substrate used is a film substrate or thin polyethylene sheet, and so it is still difficult to apply printing and processing to hard materials now in great need in general, and a polypropylene sheet in particular, because ink film strength such as adhesion and flexibility is insufficient.

JP(A)'s 2008-163342 and 2008-248251 propose a radical polymerizable ink having a viscosity lowered by use of acrylamide, hydroxyalkyl acrylate or the like. However, these acryl monomers have an increased irritation to the skin; for instance, hydroxyethyl acrylate has a P.I.I. value of 7.2 that may cause erythema or edema in actual printing worksites. Besides, JP(A)2003-252979 and WO2006/064638 pamphlet propose an oxetane skeleton-containing monomer. Although that monomer is well suited for cathionic polymerization, it may often cause erythema or edema by virtue of an increased irritation to the skin, as can be seen from the fact that, for instance, xylene bisoxetane has a P.I.I. value of 2.6 and 2-ethylhexyloxetane has a P.I.I. value of 3.1. Moreover, JP(A)2008-19292 proposes a photolithography composition having a P.I.I. value of up to 4.0, and JP(A)2003-165930 proposes a coating material having a P.I.I. value of up to 3.0; however, such P.I.I. values would be high enough to cause erythema or edema.

JP(A)'s 2006-199924 and 2008-223014 propose an ink jet ink having a low P.I.I. value; however, the performance of the ink film after curing is insufficient for practical use. Further, widely used general monomers offer an environmental problem on worksites because of strong foul smells. This in turn requires some smell preventives such as the installation of exhaust means on or in printers, and ventilations on worksites. These smell preventives cost much. Thus, the development of a less-smelling energy beam curing type ink jet ink is urgently necessary.

On the other hand, many proposals have so far been made on substrates to which printing is applied, too. Much use has been made of soft plastic films such as polyvinyl chloride, polycarbonate, PET, ABS and polyolefin films and hard plastic sheets. Where the substrate has a low surface tension, however, ink is repelled off, resulting in the peeling of the ink film after curing. Therefore, processes involving pre-treatments have been proposed as set forth in JP(A)'s 2005-7577, 2004-42465 and 2007-283627. To obtain sufficient printing quality, adhesion, flexibility and other physical properties, it is necessary to previously adjust the surface energy of the substrate by methods such as the coating of a primer on the substrate as well as flame treatment, plasma treatment, and liquid treatment prior to the jetting of ink. Much cost and time are taken for the installation of substrate surface treatments. However, the absence of any substrate surface treatment would be likely to give rise to the peeling of the printed matter.

Never until now is any active energy curing type ink jet composition available that uses a monomer having a reduced primary irritation index (P.I.I.) and that is satisfactory in terms of performance such as low viscosity, curability and adhesion to substrates and practically usable.

It is one object of the invention to provide an ink composition of ink jet recording of the active energy curing type that shows good ejection capability and curability, few smells and has a reduced primary irritation index (P.I.I.), is of great safety and has good adhesion to a variety of substrates. It is another object of the invention to provide a printed article obtained by use of that ink composition for ink jet recording of the active energy beam curing type, which is improved in terms of adhesion to the substrate after curing and stretchability.

### DISCLOSURE OF THE INVENTION

The invention provides an ink composition for ink jet recording of the active energy beam curing type, characterized by comprising:
(1) 30 to 80% by mass of a monofunctional acrylate having a monoalicyclic structure,
(2) 1 to 10% by mass of an urethane acrylate oligomer, and
(3) 5 to 30% by weight of N-vinylcaprolactam
   together with a polymerization initiator and a coloring agent, and having a viscosity at 40° C. of 5 to 20 mPa·s and a surface tension of 20 to 50 mN/m.

The ink composition of the invention is further characterized in that the monofunctional acrylate having a monoalicyclic structure is 4-t-butylcyclohexyl acrylate.

The ink composition of the invention is further characterized by containing a monofunctional acrylate including an aromatic group or an aliphatic group.

The ink composition of the invention is further characterized in that the ratio of the content of said urethane acrylate oligomer/the total content of said mono-functional acrylate having a monoalicyclic structure, said monofunctional acrylate containing an aromatic group or an aliphatic group and said N-vinylcaprolactam is 1/10 to 1/40 (by mass).

The ink composition of the invention is further characterized by being used to apply printing to a hard or soft plastic substrate having a surface tension of 25 to 50 mN/m.

The ink composition of the invention is further characterized by having a stretchability of 150% or greater after curing.

The ink composition of the invention is further characterized in that the energy necessary for curing is up to 50 mJ/cm².

The invention also provides a printed article obtained by ink jetting recording to the surface of a hard or soft plastic substrate having a surface tension of 25 to 50 mN/m of said ink composition for ink jet recording of the active energy beam curing type.

The invention further provides a printed article obtained by ink jet recording using an ink composition for ink jet recording of the active energy beam curing type having a stretchability of 150% or greater after curing.

It is noted that the “acrylate” used here means an acrylate or a methacrylate.

The ink composition for ink jet recording of the active energy bean curing type shows good ejection capability and curability, smells less strongly and has a decreased primary irritation index (P.I.I.), is of great safety, and has good adhesion to a variety of substrates, and the printed article of the invention is the one that is obtained by the ink jet recording using that ink composition, and is improved in terms of post-curing adhesion and stretchability.

### BEST MODE FOR CARRYING OUT THE INVENTION

Having an eye on the fact that when the monomer having an alicyclic structure is used as the ingredient of an ink composition for ink jet recording of the active energy beam curing type, it achieves good curability and adhesion, the inventors have made studies and thus have found that monomers having a dicyclopentadiene skeleton have an increased irritation to the skin and smell strongly; for instance, dicyclopentenyl acrylate and dicyclopentenyl-oxyethyl acrylate have an increased primary irritation index (P.I.I.) value of 4.0 and 3.7, respectively, and so are unsuitable for ink jet recording ink purposes. The inventors have also found that among monofunctional monomers having a decreased irritation to the skin, there is isobornyl acrylate (with a P.I.I. value of 0.6), but it smells very strongly, having adverse influences on worksite environments. For this reason, even the monomer having an alicyclic structure that is a monofunctional monomer having good curability and adhesion should more preferably smell less strongly and have a decreased primary irritation index (P.I.I.) of less than 1.0 to provide a safe yet comfortable worksite environment.

For the monomer having a monoalicyclic structure that has a decreased primary irritation index (P.I.I.) of less than 1.0, smells less strongly and has good curability and adhesion, it has now been found that the monomer comprises an alkylcyclohexyl acrylate as a main composition. Such an alkylcyclohexyl acrylate, for instance, includes dimethylcyclohexyl acrylate, 3,3,5-trimethylcyclohexyl acrylate and 4-t-butylcyclohexyl acrylate; however, 4-t-butylcyclohexyl acrylate is most preferred because it has a decreased irritation to the skin (the P.I.I. value of 0.8), smells less strongly and ensures an increased ink film strength after curing. For instance, “Laromer TBCH” and “Blenmer TBCHA” are commercially available from BASF Inc. and NOF Corporation.

Such a monofunctional acrylate having a mono-alicyclic structure should be contained in the ink composition in an amount of 30% by mass to 80% by mass, and preferably 40% by mass to 70% by mass. Any departure from this range will offer a problem with curability and adhesion.

It has also been found that by containing the urethane acrylate oligomer and N-vinylcaprolactam are contained together with the monofunctional acrylate having a monoalicyclic structure in the inventive ink composition, there can be a printed article obtained, which shows much more improved adhesion to a hard or soft plastic substrate that has had difficulty in receiving ink in close contact relation and has a surface tension of 25 mN/m to 50 mN/m, especially 25 mN/m to 40 mN/m as well as improved stretchability.

The urethane acrylate oligomer is a di- or poly-functional one having a urethane bond, and includes, for instance, CN968, CN9006, CN9010, CN9011, CN991, CN996, CN9893, CN9001, CN3210, CN9009, CN2902, CN2921, CN3211, CN9782, CN9788 and CN983, all available from Sartomer Company Inc. with P.I.I. values of less than 1.

The inventive ink composition should contain the urethane acrylate oligomer in an amount of 1% by mass or more, preferably 1% by mass to 10% by mass, and more preferably 2% by mass to 10% by mass of the whole ink. As the amount of the urethane acrylate oligomer used comes within the above range, it makes sure improved curability, improved flexibility of the cured film, and improved adhesion of the cured film to substrates.

N-vinylcaprolactam is preferable because of having none of the primary irritation to the skin and great safety, being generally available at relatively low costs, and being improved in terms of ink curability, flexibility of the cured film and adhesion of the cured film to substrates. The inventive ink composition should contain N-vinylcaprolactam in an amount of 5% by mass or more, preferably 5% by mass to 40% by mass, and more preferably 5% by mass to 30% by mass of the whole ink. As the amount of N-vinylcaprolactam used comes within the above range, it makes sure improved curability, improved flexibility of the cured film and improved adhesion of the cured film to substrates.

The inventive ink composition may further contain the aromatic or aliphatic monofunctional acrylate that has a primary irritation index (P.I.I.) of less than 1.0 and smells less strongly. Such a monofunctional acrylate, for instance, includes M-101A (phenol EO modified acrylate having a P.I.I. value of 0.7), M-102 (phenol EO modified acrylate having a P.I.I. value of 0.0, and M-117 (nonyl phenol PO modified acrylate having a P.I.I. value of 0.6), all available from TOAGOSEI Co., Ltd.; EBECRYL114 (ethoxylated phenyl acrylate having a P.I.I. value of 0.6) available from DAICEL-CYTECT Company Ltd.; SR339A (2-phenoxyethyl acrylate having a P.I.I. value of 0.5), SR489D (tridecyl acrylate having a P.I.I. value of 0.7), SR614 (alkoxylated nonylphenol acrylate having a P.I.I. value of 0.6), CD9087 (alkoxylated phenol acrylate having a P.I.I. value of 0.7), and CD9088 (alkoxylated phenol acrylate having a P.I.I. value of 0.0), all available from Sartomer Company Inc.; and NOAA (n-octyl acrylate having a P.I.I. value of 0.7) available from Osaka Organic Chemical Industry Inc.

The content ratio (by mass) of the aforesaid urethane acrylate oligomer and other polymerization components, viz., the content of the urethane acrylate oligomer)/the total content of the aforesaid mono-functional acrylate having a monoalicyclic structure, the aforesaid monofunction acrylate having an aromatic or aliphatic group and N-vinylcaprolactam should be in the range of 1/10 to 1/40, and preferably 1/10 to 1/30. As the content ratio of the urethane acrylate oligomer comes within the above range, it makes sure improved curability, improved flexibility of the cured film and improved adhesion of the cured film to substrates.

For the coloring agent, there is the mention of pigments used so far for conventional ink jet inks, for instance, uncolored or colored organic pigments such as carbon black, titanium oxide and calcium carbonate, colored organic pigments as well as dyes. These coloring agents may be used alone or in combination of two or more. For instance, the organic pigment includes insoluble azo pigments, soluble azo pigments, derivatives from dyes, phthalocyanine organic pigments, quinacridone organic pigments, perylene organic pigments, isoindolinone organic pigments, pyranthrone organic pigments, thioindigo organic pigments, condensed azo organic pigments, benzimidazolone organic pigments, quinophthalone organic pigments and isoindoline organic pigments as well as known and generally used other pigments such as nickel azo yellow and dioxazine violet.

In terms of color index (C.I.) numbers, for instance, the organic pigments are represented by:

C.I. Pigment Yellow 1, 2, 3, 12, 13, 14, 16, 17, 20, 24, 73, 74, 75, 83, 93, 95, 97, 98, 109, 110, 114, 117, 120, 125, 128, 129, 130, 137, 138, 139, 147, 148, 150, 151, 153, 154, 155, 166, 168, 180, 185, 213, 214;

C.I. Pigment Red 5, 7, 9, 12, 48, 49, 52, 53, 57, 97, 112, 122, 123, 149, 168, 177, 180, 184, 192, 202, 206, 209, 215, 216, 217, 220, 223, 224, 226, 227, 228, 238, 240, 254;

C.I. Pigment Orange 16, 36, 43, 51, 55, 59, 61;

C.I. Pigment Violet 19, 23, 29, 30, 37, 40, 50;

C.I. Pigment Blue 15, 15:1, 15:3, 15:4, 15:6, 16, 22, 60, 64;

C.I. Pigment Green 7, 36; and

C.I. Pigment Brown 23, 25, 26.

The aforesaid dyes, for instance, include naphthol dyes, azo dyes, anthraquinone dyes, quinoline dyes, naphthoquinone dyes, nitroso dyes, quinoneimine dyes, benzoquinone dyes, cyanine dyes, nitro dyes and metal complex salt dyes.

It is desired that the inventive ink composition for ink jet recording of the active energy beam curing type further comprise a dispersant, preferably a high-molecular dispersant. For that dispersant, use may be made of any of dispersants used with energy beam curing type ink compositions, and for the aforesaid high-molecular dispersants, use may be made of ones that comprise as a main chain a polyester, polyacryl, polyurethane, polyamine, polycaprolactone or the like and as a side chain a polar group such as an amino, carboxyl, sulfone or hydroxyl group. Preferable for the aforesaid high-molecular dispersants, for instance, are SOLSPERSE from The Lubrizol Corp., DISPERBYK from BYK Chemie Co., Ltd.; and EFKA from EFKA Co., Ltd. For instance, there is the mention of SOLSPERSE32000 from The Lubrizol Corp., and Disperbyk-168 from BYK Chemie Co., Ltd.

For the polymerization initiator that may be used here, there is the mention of radical ones used so far in the art. In the invention, the radical polymerization initiators may be used alone or in combination of two or more.

For the radial polymerization initiators that may be used here, for instance, there is the mention of aromatic ketones, acylphosphine compounds, aromatic onium salt compounds, organic peroxides, thio compounds, hexa-arylbiimidazole compounds, ketooxime ester compounds, borate compounds, azinium compounds, metallocene compounds, active ester compounds, compounds containing carbon-halogen bonds and alkylamine compounds. For these radical polymerization initiators, the aforesaid compounds may be used alone or in combination of two or more. The radical polymerization initiators here may be used alone or in combination of two or more.

The amount of the photopolymerization initiator to be blended in the inventive ink composition for ink jet recording of the active energy beam curing type is preferably 0.1 to 10 parts by mass, and more preferably 1 to 8 parts by mass per 100 parts by mass of the total of the energy beam curable monomer and oligomer.

The inventive ink composition for ink jet recording of the active energy beam curing type may further contain a sensitizer for the purpose of enhancing the efficiency of generation of radicals in the radical polymerization initiator and making photosensitive wavelengths longer. The sensitizer that may be used here should preferably be such that the aforesaid photopolymerization initiator is sensitized via an electron or energy migration mechanism.

The inventive composition for ink jet recording of the active energy beam curing type may additionally contain a polymerization inhibitor for the purpose of preventing polymerization during storage.

Besides, the inventive composition for ink jet recording of the active energy beam curing type may contain antioxidants, stabilizers such as UV absorbers, surface active agents, and so on.

The inventive composition for ink jet recording of the active energy beam curing type may be prepared by the uniform milling and dispersion of the aforesaid respective components in known manners. For ink preparation, as an example, the aforesaid coloring agent and dispersant are added into the monomer for a one-hour stirring in a dissolver at 1,000 rpm, whereupon pre-dispersion is carried out in a bead mill charged with zirconia beads (2 mm). Dispersion is then carried out a nano-mill charged with zirconia beads (0.3 mm) to obtain a coloring agent dispersion. Then, while the ensuing dispersion is stirred at 1,500 rpm, the oligomer, and suitable amounts of the initiator and additives are added to it for uniform milling and dispersion to control the viscosity of the dispersion to 5 mPa·s to 20 mPa·s, and preferably 5 mPa·s to 15 mPa·s thereby obtaining the inventive ink.

The inventive composition for ink jet recording of the active energy beam curing type should preferably be adjusted in such a way as to have a surface tension of 20 to 50 mN/m. As the surface tension goes down below 20 mN/m, it causes the ink composition to spread out, or ooze out, the surface of an ink jet recording printer head in a wetted state, often rendering the ejection of ink droplets difficult. As the surface tension grows high in excess of 50 mN/m, it causes the ink composition not to spread over the surface of the recording medium in a wetted state, often failing to achieve good printing.

The substrate to be printed here is a hard or soft plastic material having a surface tension of 25 to 50 mM/m, for instance, polyethylene terephthalate resin, polypropylene resin, acrylic resin, polycarbonate resin, polystyrene resin, and polyvinyl chloride resin. As can be seen from the adhesion testing given later, the inventive ink composition shows improved adhesion to them.

Generally, when the surface tension of the substrate is equal to, or about 10 mN/m higher than, that of a liquid, there is sufficient adhesive force obtained. For this reason, in order for the hard or soft plastic material having a surface tension of 25 to 50 mN/m to be printed, the ink composition for ink jet recording should preferably be adjusted in such a way as to have a surface tension of 20 to 50 mN/m.

In use, the inventive ink composition for ink jet recording of the active energy beam curing type is first fed to the printer head of an ink jet recording printer. Then, the ink jet ink is ejected from the printer head onto the substrate, and thereafter irradiated with ultraviolet radiation (365 nm) for curing in an integral light quantity of as low as 50 mJ/cm² or less. As a result, the composition on the recording medium cures quickly.

It is here noted that for light sources of active energy beams, for instance, high-pressure mercury lamps, metal halide lamps, low-pressure mercury lamps, ultra-high-pressure mercury lamps, ultraviolet lasers and light-emitting diodes (LEDs) may be used in the case of irradiation with ultraviolet radiation.

By way of example but not by way of limitation, the invention is now explained with reference to specific examples.

### EXAMPLES 1-5 AND COMPARATIVE EXAMPLES 11-20

### (Preparation of the Dispersion)

Of the components set out in Table 1 given later, 5 parts by mass of the pigment, 5 parts by mass of the dispersant and 40 parts by mass of the monomer were stirred at 3,000 rpm for 1 hour in a dissolver, and thereafter pre-dispersed in a bead mill charged with zirconia beads (2 mm). Further, the dispersion was full-dispersed with zirconia beads (0.3 mm) to obtain a pigment dispersion. While the obtained pigment dispersion was stirred at 4,000 rpm, the rest of the components set out in Table 1 were mixed with it to obtain Examples 1 to 5 that are the inventive ink compositions. The components set out in Tables 2 and 3 given later were used in the same way to obtain Comparative Examples 11 to 20. For respective components of Tables 1, 2 and 3 wherein numerals are given in “parts by mass”, the following commercial products were used.
MA-14: Carbon black from Mitsubishi Chemical Co., Ltd. Blenmer TBCHA: 4-t-Butylcyclohexyl acrylate from NOF Corporation with a P.I.I. value of 0.8
SR339A: 2-Phenoxyethyl acrylate from Sartomer Company Inc. with a P.I.I. value of 0.5
SR489D: Tridecyl acrylate from Sartomer Company Inc. with a P.I.I. value of 0.7
SR9003: Propoxylated neopentyl glycol diacrylate from Sartomer Company Inc. with a P.I.I. value of 1.0
CD406: Cyclohexanedimethanol diacrylate (difunctional) from Sartomer Company Inc. with a P.I.I. value of 0.0
Fancryl FA-512A: Dicyclopentenyloxyethyl acrylate (alicyclic structure) from Hitachi Chemical Co., Ltd. with a P.I.I. value of 3.7
V-CAP/RC: N-vinylcaprolactam (having no irritation to the skin) from ISP Japan Inc.
CN968: Urethane acrylate oligomer from Sartomer Company Inc.
CN996: Urethane acrylate oligomer from Sartomer Company Inc.
CN9010: Urethane acrylate oligomer from Sartomer Company Inc.
Irgacure 369: Initiator (2-benzyl-2-dmethylamino-1-(4-morpholinophenyl)-butanone-1) from Ciba Specialty Chemicals K.K.
Lucyline TPO: Initiator (diphenyl-2,4,6-trimethylbonzoyl phosphine oxide) from BASF Japan Inc.
Disperbyk: High-molecular dispersant from BYK Chemie Japan Inc.

TABLE 1

| | Example | Example | Example | Example | Example |
|---|---|---|---|---|---|
| | 1 | 2 | 3 | 4 | 5 |
| MA-14 | 5.00 | 5.00 | 5.00 | 5.00 | 5.00 |
| Blenmer | 55.00 | 50.00 | 50.00 | 48.00 | 50.00 |
| TBCHA | | | | | |
| SR339A | 6.00 | 8.00 | 8.00 | 20.00 | — |
| SR489D | — | — | — | — | 8.00 |
| V-CAP/RC | 20.00 | 20.00 | 20.00 | 10.00 | 20.00 |
| CN968 | 1.50 | 3.00 | 3.00 | 3.00 | 3.00 |
| CN996 | 1.50 | 3.00 | — | 3.00 | 3.00 |
| CN9010 | — | — | 3.00 | — | — |
| Irg 369 | 4.00 | 4.00 | 4.00 | 4.00 | 4.00 |
| Lucyline | 2.00 | 2.00 | 2.00 | 2.00 | 2.00 |
| TPO | | | | | |
| BYK168 | 5.00 | 5.00 | 5.00 | 5.00 | 5.00 |
| Total | 100.00 | 100.00 | 100.00 | 100.00 | 100.00 |

TABLE 2

| | Compara- | Compara- | Compara- | Compara- | Compara- |
|---|---|---|---|---|---|
| | tive | tive | tive | tive | tive |
| | Example | Example | Example | Example | Example |
| | 11 | 12 | 13 | 14 | 15 |
| MA-14 | 5.00 | 5.00 | 5.00 | 5.00 | 5.00 |
| Blenmer | 64.00 | 40.00 | 48.00 | 45.00 | 28.00 |
| TBCHA | | | | | |
| SR339A | — | 10.00 | 17.00 | 16.00 | — |
| SR489D | — | — | 16.00 | 17.00 | — |
| SR9003 | — | — | — | — | — |
| CN406 | — | — | — | — | — |
| Fancryl | — | — | — | — | — |
| FA-512A | | | | | |
| V-CAP/RC | 20.00 | 20.00 | 3.00 | — | 50.00 |
| CN968 | — | 7.00 | — | 3.00 | 3.00 |
| CN996 | — | 7.00 | — | 3.00 | 3.00 |
| Irg 369 | 4.00 | 4.00 | 4.00 | 4.00 | 4.00 |
| Lucyline | 2.00 | 2.00 | 2.00 | 2.00 | 2.00 |
| TPO | | | | | |
| BYK168 | 5.00 | 5.00 | 5.00 | 5.00 | 5.00 |
| Total | 100.00 | 100.00 | 100.00 | 100.00 | 100.00 |

TABLE 3

| | Compara- | Compara- | Compara- | Compara- | Compara- |
|---|---|---|---|---|---|
| | tive | tive | tive | tive | tive |
| | Example | Example | Example | Example | Example |
| | 16 | 17 | 18 | 19 | 20 |
| MA-14 | 5.00 | 5.00 | 5.00 | 5.00 | 5.00 |
| Blenmer | 79.00 | 20.00 | — | — | — |
| TBCHA | | | | | |
| SR339A | — | 10.00 | 30.00 | 8.00 | 8.00 |
| SR489D | — | — | 28.00 | — | — |
| SR9003 | — | 28.00 | — | — | — |
| CN406 | — | — | — | 50.00 | — |
| Fancryl | — | — | — | — | 50.00 |
| FA-512A | | | | | |
| V-CAP/RC | 3.00 | 20.00 | 20.00 | 20.00 | 20.00 |
| CN968 | 1.00 | 3.00 | 3.00 | 3.00 | 3.00 |
| CN996 | 1.00 | 3.00 | 3.00 | 3.00 | 3.00 |
| Irg 369 | 4.00 | 4.00 | 4.00 | 4.00 | 4.00 |
| Lucyline | 2.00 | 2.00 | 2.00 | 2.00 | 2.00 |
| TPO | | | | | |
| BYK168 | 5.00 | 5.00 | 5.00 | 5.00 | 5.00 |
| Total | 100.00 | 100.00 | 100.00 | 100.00 | 100.00 |

The active energy beam curing type ink compositions obtained according to Examples 1 to 5 and Comparative Examples 11 to 20 were evaluated for the following points to check.

### (Viscosity)

Viscosity was measured at 40° C. with B-Type Viscometer RA11-4851 from Toki Sangyo Co., Ltd.

### (Surface Tension)

Ink samples were measured at 40° C. with CBVP-Z from Kyowa Interface Science Co. Ltd., and substrate samples were measured with Tension Checker from Pacific Chemical Ltd.

### (Ejection Capability)

Ejection testing was carried out on an ink jet recorder (SE-128 from Dimatix Ltd.) equipped with a piezo type ink jet nozzle.

Solid printing was carried out continuously for 1 hour at an ejection temperature of 40° C. and a driving frequency of 10 kHz to make evaluation of ejection states.
◯: Dot missing, fly bending or ink scattering occurred less than 10 times.
Δ: Dot missing, fly bending or ink scattering occurred ten times to up to 20 times.
X: Dot missing, fly bending or ink scattering occurred at least 20 times.

### (Curability)

After curing with 365-nm ultraviolet radiation at an integral light quantity of as low as 50 mJ/cm², curability was visually evaluated.
◯: Perfect curing was achieved.
Δ: Substantial, if not perfect, curing was achieved.
×: Only partial curing occurred.

### (Solvent Resistance)

A coating film obtained as was the case with the samples used for the evaluation of adhesion to be described later was rubbed 10 times in both ways with an ethanol-impregnated swab under an about 100 grams load to visually check what state the coating film was in pursuant to the following evaluation criteria.
◯: The coating film did not peel off even with 10 rubbings.
Δ: The coating film peeled off with 5 to 10 rubbings.
×: Peeling occurred with 1 to 4 rubbings.

### (Adhesion)

After a solid image having an average thickness of 3 was written on the following substrate, curing was implemented at 50 mJ/cm². According to the cloth cut adhesion testing pursuant to ASTM D3359, evaluation was carried out as follows.
PET: PET film (ester film from Toyobo Co. Ltd. with a surface tension of 49 mN/m)
PP: Polypropylene sheet (Coroplast from Coroplast Co., Ltd. with a surface tension of 34 mN/m)
AC: Acryl sheet “Acrylight from Mitsubishi Rayon Co., Ltd. with a surface tension of 38 mN/m)
PC: Polycarbonate sheet (Lexan from AGC with a surface tension of 36 mN/m)
5B: No peeling occurred whatsoever.
4B: Less than 5% peeling occurred.
3B: 5% to less than 15% peeling occurred.
2B: 15% to less than 35% peeling occurred.
1B: 35% to less than 65% peeling occurred.
0B: More than 65% peeling occurred.

### (Stretchability)

Ink was coated and cured on an acryl sheet sized to 1 cm×10 cm in the same way as the samples used for the evaluation of adhesion, after which the sample was heated to 150° C. and stretched at both ends at a speed of 0.5 m/s to a length of about 25 cm.
◯: There was no crack in the coating film.
Δ: There was a visible crack occurred in the coating film.
×: The coating film peeled off due to a cleft.

The obtained results are shown in Tables 4 to 6.

TABLE 4

| | Example | Example | Example | Example | Example |
|---|---|---|---|---|---|
| | 1 | 2 | 3 | 4 | 5 |
| Viscosity | 8.00 | 11.0 | 10.5 | 10.0 | 9.5 |
| (mPa · s) | | | | | |
| Surface | 25.0 | 25.4 | 25.4 | 25.3 | 25.2 |
| Tension | | | | | |
| (mN/m) | | | | | |
| Ejection | ◯ | ◯ | ◯ | ◯ | ◯ |
| Capability | | | | | |
| Curability | ◯ | ◯ | ◯ | ◯ | ◯ |
| Solvent | ◯ | ◯ | ◯ | ◯ | ◯ |
| Resistance | | | | | |
| Adhesion to | 5B | 5B | 5B | 5B | 5B |
| PET | | | | | |
| Adhesion to | 5B | 5B | 5B | 5B | 5B |
| PP | | | | | |
| Adhesion to | 5B | 5B | 5B | 5B | 5B |
| AC | | | | | |
| Adhesion to | 5B | 5B | 5B | 5B | 5B |
| PC | | | | | |
| Strechability | ◯ | ◯ | ◯ | ◯ | ◯ |

TABLE 5

| | Compara- | Compara- | Compara- | Compara- | Compara- |
|---|---|---|---|---|---|
| | tive | tive | tive | tive | tive |
| | Example | Example | Example | Example | Example |
| | 11 | 12 | 13 | 14 | 15 |
| Viscosity | 6.5 | 16.0 | 6.0 | 5.5 | 9.5 |
| (mPa · s) | | | | | |
| Surface | 24.5 | 25.6 | 24.5 | 24.3 | 25.0 |
| Tension | | | | | |
| (mN/m) | | | | | |
| Ejection | ◯ | Δ | X | ◯ | X |
| Capability | | | | | |
| Curability | Δ | ◯ | X | X | Δ |
| Solvent | Δ | ◯ | Δ | X | Δ |
| Resistance | | | | | |
| Adhesion | 2B | 0B | 1B | 0B | 0B |
| to PET | | | | | |
| Adhesion | 2B | 0B | 1B | 0B | 0B |
| to PP | | | | | |
| Adhesion | 2B | 0B | 1B | 0B | 0B |
| to AC | | | | | |
| Adhesion | 2B | 0B | 1B | 0B | 0B |
| to PC | | | | | |
| Strechability | X | X | X | X | X |

TABLE 6

| | Compara- | Compara- | Compara- | Compara- | Compara- |
|---|---|---|---|---|---|
| | tive | tive | tive | tive | tive |
| | Example | Example | Example | Example | Example |
| | 16 | 17 | 18 | 19 | 20 |
| Viscosity | 8.5 | 14.0 | 5.0 | 23.0 | 20.0 |
| (mPa · s) | | | | | |
| Surface | 24.8 | 25.5 | 24.3 | 25.8 | 25.7 |
| Tension | | | | | |
| (mN/m) | | | | | |
| Ejection | ◯ | Δ | X | Δ | Δ |
| Capability | | | | | |
| Curability | X | ◯ | X | ◯ | ◯ |
| Solvent | X | ◯ | X | ◯ | ◯ |
| Resistance | | | | | |
| Adhesion | 0B | 0B | 0B | 0B | 0B |
| to PET | | | | | |
| Adhesion | 0B | 0B | 0B | 0B | 0B |
| to PP | | | | | |
| Adhesion | 0B | 0B | 0B | 0B | 0B |
| to AC | | | | | |
| Adhesion | 0B | 0B | 0B | 0B | 0B |
| to PC | | | | | |
| Strechability | X | X | X | X | X |

As can be appreciated from Table 4, Examples 1 to 5 wherein 30 to 80% by mass of the monofunctional acrylate having a monoalicyclic structure, 1 to 10% by mass of the urethane acrylate oligomer and 5 to 30% by mass of N-vinylcaprolactam were used showed good curability, adhesion and stretchability.

As can be seen from Tables 5 and 6, by contrast, the comparative examples that contained none or smaller amounts of 4-t-butylcyclohexyl acrylate were poor in adhesion and stretchability. Acrylates having a di-functional or polycyclic structure were found to be poor in adhesion and stretchability. Any deviation of the content of the urethane acrylate oligomer and N-vinyl-caprolactam from the range claimed here resulted in negative evaluation.

### INDUSTRIAL APPLICABILITY

The inventive ink composition for ink jet recording of the active energy beam curing type exhibits good ejection capability and curability, has a limited primary irritation index (P.I.I.) and is of great safety with reduced foul smells. A printed article obtained using that ink composition is improved in terms of adhesion and stretchability. The inventive ink composition is best suited to a variety of substrates, providing good printed articles.

What is claimed is:

1. An ink composition for ink jet recording of the active energy beam curing type, characterized by comprising:
(1) 30 to 80% by mass of a monofunctional acrylate having a monoalicyclic structure,
(2) 1 to 10% by mass of an urethane acrylate oligomer, and
(3) 5 to 30% by mass of N-vinylcaprolactam
together with a polymerization initiator and a coloring agent, and having a viscosity at 40° C. of 5 to 20 mPa·s and a surface tension of 20 to 50 mN/m.

2. The ink composition according to claim 1, wherein the monofunctional acrylate having a mono-alicyclic structure is 4-t-butylcyclohexyl acrylate.

3. The ink composition according to claim 1, characterized by further containing a monofunctional acrylate including an aromatic group or an aliphatic group.

4. The ink composition according to claim 1, wherein a ratio of the content of said urethane acrylate oligomer/the total content of said monofunctional acrylate having a monoalicyclic structure, said monofunctional acrylate containing an aromatic group or an aliphatic group and said N-vinylcaprolactam is 1/10 to 1/40 (by mass).

5. The ink composition according to claim 1, which is used for printing to a hard or soft plastic substrate having a surface tension of 25 to 50 mN/m.

6. The ink composition according to claim 1, which has a stretchability of 150% or greater after curing.

7. The ink composition according to claim 1, wherein the energy necessary for curing is up to 50 mJ/cm².

8. A printed article obtained by ink jetting recording to a surface of a hard or soft plastic substrate having a surface tension of 25 to 50 mN/m of an ink composition for ink jet recording of the active energy beam curing type as recited in claim 1.

9. A printed article obtained by ink jet recording using an ink composition for ink jet recording of the active energy beam curing type as recited in claim 6.
